(19) United States
(12) Patent Application Publication
(10) Pub. No.: US 2008/0267177 A1
(43) Pub. Date: Oct. 30, 2008

(54) Method and system for virtualization of packet encryption offload and onload

(75) Inventors: Darrin P. Johnson, San Jose, CA (US); Kais Belgaied, Sunnyvale, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/789,337

(22) Filed: Apr. 24, 2007

(51) Int. Cl. H04L 12/56

(52) U.S. Cl. 370/389

(57) ABSTRACT

A method for processing a packet includes receiving the packet in a network interface card (NIC), obtaining a first classification for the packet, placing the packet in one of a first plurality of receive rings based on the first classification, obtaining a security association (SA) from one of a plurality of security association database (SADB) partitions, decrypting the packet using the SA, obtaining a security policy (SP) from one of a plurality of security policy database (SPD) partitions, determining an admittance of the packet based on the SP, obtaining a second classification for the packet based on the admittance, placing the packet in one of a second plurality of receive rings based on the second classification, and sending the packet to a host operatively connected to the NIC, wherein the packet is further processed by the host.

### CROSS-REFERENCE TO RELATED APPLICATIONS

The present application contains subject matter that may be related to the subject matter in the following U.S. applications filed on Apr. 22, 2005, and assigned to the assignee of the present application: “Method and Apparatus for Managing and Accounting for Bandwidth Utilization Within A Computing System” with U.S. application Ser. No. 11/112,367 (Attorney Docket No. 03226/643001; SUN050681); “Method and Apparatus for Consolidating Available Computing Resources on Different Computing Devices” with U.S. application Ser. No. 11/112,368 (Attorney Docket No. 03226/644001; SUN050682); “Assigning Higher Priority to Transactions Based on Subscription Level” with U.S. application Ser. No. 11/112,947 (Attorney Docket No. 03226/645001; SUN050589); “Method and Apparatus for Dynamically Isolating Affected Services Under Denial of Service Attack” with U.S. application Ser. No. 11/112,158 (Attorney Docket No. 03226/646001; SUN050587); “Method and Apparatus for Improving User Experience for Legitimate Traffic of a Service Impacted by Denial of Service Attack” with U.S. application Ser. No. 11/112,629 (Attorney Docket No. 03226/647001; SUN050590); “Method and Apparatus for Limiting Denial of Service Attack by Limiting Traffic for Hosts” with U.S. application Ser. No. 11/112,328 (Attorney Docket No. 03226/648001; SUN050591); “Hardware-Based Network Interface Per-Ring Resource Accounting” with U.S. application Ser. No. 11/112,222 (Attorney Docket No. 03226/649001; SUN050593); “Dynamic Hardware Classification Engine Updating for a Network Interface” with U.S. application Ser. No. 11/112,934 (Attorney Docket No. 03226/650001; SUN050592); “Network Interface Card Resource Mapping to Virtual Network Interface Cards” with U.S. application Ser. No. 11/112,063 (Attorney Docket No. 03226/651001; SUN050588); “Network Interface Decryption and Classification Technique” with U.S. application Ser. No. 11/112,436 (Attorney Docket No. 03226/652001; SUN050596); “Method and Apparatus for Enforcing Resource Utilization of a Container” with U.S. application Ser. No. 11/112,910 (Attorney Docket No. 03226/653001; SUN050595); “Method and Apparatus for Enforcing Packet Destination Specific Priority Using Threads” with U.S. application Ser. No. 11/112,584 (Attorney Docket No. 03226/654001; SUN050597); “Method and Apparatus for Processing Network Traffic Associated with Specific Protocols” with U.S. application Ser. No. 11/112,228 (Attorney Docket No. 03226/655001; SUN050598).

The present application contains subject matter that may be related to the subject matter in the following U.S. applications filed on Oct. 21, 2005, and assigned to the assignee of the present application: “Method and Apparatus for Defending Against Denial of Service Attacks” with U.S. application Ser. No. 11/255,366 (Attorney Docket No. 03226/688001; SUN050966); “Router Based Defense Against Denial of Service Attacks Using Dynamic Feedback from Attacked Host” with U.S. application Ser. No. 11/256,254 (Attorney Docket No. 03226/689001; SUN050969); and “Method and Apparatus for Monitoring Packets at High Data Rates” with U.S. application Ser. No. 11/226,790 (Attorney Docket No. 03226/690001; SUN050972).

The present application contains subject matter that may be related to the subject matter in the following U.S. applications filed on Jun. 30, 2006, and assigned to the assignee of the present application: “Network Interface Card Virtualization Based On Hardware Resources and Software Rings” with U.S. application Ser. No. 11/479,046 (Attorney Docket No. 03226/870001; SUN061020); “Method and System for Controlling Virtual Machine Bandwidth” with U.S. application Ser. No. 11/480,000 (Attorney Docket No. 03226/871001; SUN061021); “Virtual Switch” with U.S. application Ser. No. 11/480,261 (Attorney Docket No. 03226/873001; SUN061023); “System and Method for Virtual Network Interface Cards Based on Internet Protocol Addresses” with U.S. application Ser. No. 11/479,997 (Attorney Docket No. 03226/874001; SUN061024); “Virtual Network Interface Card Loopback Fastpath” with U.S. application Ser. No. 11/479,946 (Attorney Docket No. 03226/876001; SUN061027); “Bridging Network Components” with U.S. application Ser. No. 11/479,948 (Attorney Docket No. 03226/877001; SUN061028); “Reflecting the Bandwidth Assigned to a Virtual Network Interface Card Through Its Link Speed” with U.S. application Ser. No. 11/479,161 (Attorney Docket No. 03226/878001; SUN061029); “Method and Apparatus for Containing a Denial of Service Attack Using Hardware Resources on a Virtual Network Interface Card” with U.S. application Ser. No. 11/480,100 (Attorney Docket No. 03226/879001; SUN061033); “Virtual Network Interface Cards with VLAN Functionality” with U.S. application Ser. No. 11/479,998 (Attorney Docket No. 03226/882001; SUN061037); “Method and Apparatus for Dynamic Assignment of Network Interface Card Resources” with U.S. application Ser. No. 11/479,817 (Attorney Docket No. 03226/883001; SUN061038); “Generalized Serialization Queue Framework for Protocol Processing” with U.S. application Ser. No. 11/479,947 (Attorney Docket No. 03226/884001; SUN061039); “Serialization Queue Framework for Transmitting Packets” with U.S. application Ser. No. 11/479,143 (Attorney Docket No. 03226/885001; SUN061040).

The present application contains subject matter that may be related to the subject matter in the following U.S. applications filed on Jul. 20, 2006, and assigned to the assignee of the present application: “Low Impact Network Debugging” with U.S. application Ser. No. 11/489,926 (Attorney Docket No. 03226/829001; SUN060545); “Reflecting Bandwidth and Priority in Network Attached Storage I/O” with U.S. application Ser. No. 11/489,936 (Attorney Docket No. 03226/830001; SUN060587); “Priority and Bandwidth Specification at Mount Time of NAS Device Volume” with U.S. application Ser. No. 11/489,934 (Attorney Docket No. 03226/831001; SUN060588); “Notifying Network Applications of Receive Overflow Conditions” with U.S. application Ser. No. 11/490,821 (Attorney Docket No. 03226/869001; SUN060913); “Host Operating System Bypass for Packets Destined for a Virtual Machine” with U.S. application Ser. No. 11/489,943 (Attorney Docket No. 03226/872001; SUN061022); “Multi-Level Packet Classification” with U.S. application Ser. No. 11/490,745 (Attorney Docket No. 03226/875001; SUN061026); “Method and System for Automatically Reflecting Hardware Resource Allocation Modifications” with U.S. application Ser. No. 11/490,582 (Attorney Docket No. 03226/881001; SUN061036); “Multiple Virtual Network Stack Instances Using Virtual Network Interface Cards” with U.S. application Ser. No. 11/489,942 (Attorney Docket No. 03226/888001; SUN061041); “Method and System for Network Configuration for Containers” with U.S. application Ser. No. 11/490,479 (Attorney Docket No. 03226/889001; SUN061044); “Network Memory Pools for Packet Destinations and Virtual Machines” with U.S. application Ser. No. 11/490,486 (Attorney Docket No. 03226/890001; SUN061062); “Method and System for Network Configuration for Virtual Machines” with U.S. application Ser. No. 11/489,923 (Attorney Docket No. 03226/893001; SUN061171); and “Shared and Separate Network Stack Instances” with U.S. application Ser. No. 11/489,933 (Attorney Docket No. 03226/898001; SUN061200).

The present application contains subject matter that may be related to the subject matter in the following U.S. applications filed on Nov. 28, 2006, and assigned to the assignee of the present application: “Virtual Network Testing and Deployment using Network Stack Instances and Containers” with U.S. application Ser. No. 11/605,114 (Attorney Docket No. 03226/892001; SUN061072) and “Method and System for Creating A Demilitarized Zone using Network Stack Instances” with U.S. application Ser. No. 11/642,427 (Attorney Docket No. 03226/891001; SUN061071) filed on Dec. 20, 2006.

The present application contains subject matter that may be related to the subject matter in the following U.S. application filed on Dec. 20, 2006, and assigned to the assignee of the present application: “Network Stack Instance Architecture with Selection of Transport Layers” with U.S. application Ser. No. 11/642,490 (Attorney Docket No. 03226/854001; SUN061184); “Method and System for Virtual Routing Using Containers” with U.S. application Ser. No. 11/642,756 (Attorney Docket No. 03226/897001; SUN061199).

The present application contains subject matter that may be related to the subject matter in the following U.S. applications filed on Mar. 30, 2007, and assigned to the assignee of the present application: “Method and System for Security Protocol Partitioning and Virtualization” with U.S. application Ser. No. 11/731,601 (Attorney Docket No. 03227/015001; SUN070042); and “Method and System for Inheritance of Network Interface Card Capabilities” with U.S. application Ser. No. 11/731,458 (Attorney Docket No, 03227/016001; SUN070022).

The present application contains subject matter that may be related to the subject matter in the following U.S. applications will be filed on Apr. 25, 2007, and assigned to the assignee of the present application: “Method and System for Combined Security Protocol and Packet Filter Offload and Onload” with U.S. application Ser. No. TBD (Attorney Docket No. 03227/030001; SUN070413).

### BACKGROUND

Network traffic is transmitted over a network, such as the Internet, from a sending system (e.g., a computer system) to a receiving system (e.g., a computer system) via a physical network interface card (NIC). The NIC is a piece of hardware found in a typical computer system that includes functionality to send and receive network traffic. Typically, network traffic is transmitted in the form of packets, where each packet includes a header and a payload. The header contains information regarding the source address, destination address, size, transport protocol used to transmit the packet, and various other identification information associated with the packet. The payload contains the actual data to be transmitted from the network to the receiving system.

Each of the packets sent between the sending system and receiving system is typically associated with a connection. The connection ensures that packets from a given process on the sending system reach the appropriate process on the receiving system. The connection may also be secured by encrypting and authenticating the packets before transmission. Packets received by the receiving system (via a NIC associated with the receiving system) are analyzed by a classifier to determine the connection associated with the packet. If the packets are encrypted, the packets may be decrypted by the CPU, or by a cryptographic offload engine located elsewhere on the receiving system.

Typically, the classifier includes a connection data structure that includes information about active connections on the receiving system. The connection data structure may include the following information about each active connection: (i) the queue associated with the connection; and (ii) information necessary to process the packets on the queue associated with the connection. Depending on the implementation, the connection data structure may include additional information about each active connection. Such queues are typically implemented as first-in first-out (FIFO) queues and are bound to a specific central processing unit (CPU) on the receiving computer system. Thus, all packets for a given connection are placed in the same queue and are processed by the same CPU. In addition, each queue is typically configured to support multiple connections.

Once the classifier determines the connection associated with the packets, the packets are sent to a temporary data structure (e.g., a receive ring on the NIC) and an interrupt is issued to the CPU associated with the queue. In response to the interrupt, a thread associated with the CPU (to which the serialization queue is bound) retrieves the packets from the temporary data structure and places them in the appropriate queue. Once packets are placed in the queue, those packets are processed in due course. In some implementations, the queues are implemented such that only one thread is allowed to access a given queue at any given time.

### SUMMARY

In general, in one aspect, the invention relates to a method for processing a packet, comprising receiving the packet in a network interface card (NIC), obtaining a first classification for the packet, placing the packet in one of a first plurality of receive rings based on the first classification, obtaining a security association (SA) from one of a plurality of security association database (SADB) partitions, wherein the one of the plurality of SADB partitions is associated with the one of the first plurality of receive rings, decrypting the packet using the SA, obtaining a security policy (SP) from one of a plurality of security policy database (SPD) partitions, wherein the one of the plurality of SPD partitions is associated with the one of the first plurality of receive rings, determining an admittance of the packet based on the SP, obtaining a second classification for the packet based on the admittance, placing the packet in one of a second plurality of receive rings based on the second classification, and sending the packet to a host operatively connected to the NIC, wherein the packet is further processed by the host.

In general, in one aspect, the invention relates to a network interface card (NIC), comprising a first classifier configured to obtain a first classification for the packet, a first plurality of receive rings, wherein the packet is placed in one of the first plurality of receive rings based on the first classification, a plurality of security association database (SADB) partitions, wherein each of the plurality of SADB partitions is associated with one of the first plurality of receive rings, a cryptographic offload engine configured to decrypt the packet using a security association (SA) from one of the plurality of SADB partitions, a plurality of security policy database (SPD) partitions, wherein each of the plurality of SPD partitions is associated with one of the first plurality of receive rings, a policy engine configured to determine an admittance of the packet using a security policy (SP) from one of the plurality of SPD partitions, a second classifier configured to obtain a second classification for the packet, and a second plurality of receive rings, wherein the packet is placed in one of the second plurality of receive rings based on the second classification.

In general, in one aspect, the invention relates to a method for processing a packet, comprising receiving the packet from a host, wherein the packet comprises a destination address, placing the packet in one of a first plurality of transmit rings, obtaining a security policy (SP) from one of a plurality of security policy database (SPD) partitions, wherein the one of the plurality of SPD partitions is associated with the one of the first plurality of transmit rings, determining a security level of the packet based on the SP, obtaining a security association (SA) from one of a plurality of security association database (SADB) partitions based on the security level, wherein the one of the plurality of SADB partitions is associated with the one of the first plurality of transmit rings, encrypting the packet using the SA, placing the packet in one of a second plurality of transmit rings, and sending the packet over a network connection to the destination address.

Other aspects of the invention will be apparent from the following description and the appended claims.

### BRIEF DESCRIPTION OF DRAWINGS

FIGS. 1-2 show systems in accordance with one or more embodiments of the invention.

FIGS. 3-5 show flow diagrams in accordance with one or more embodiments of the invention.

FIG. 6 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system to partition and virtualize packet security and steering. Packet security may include encryption, decryption, and authentication of packets, as well as admittance and denial of packet entry into or exit from a system. In one embodiment of the invention, packet steering may include hardware classification of packets based on packet header and/or payload and placement of packets into appropriate receive and transmit rings based on the classification. In one embodiment of the invention, packet security may be implemented using a security protocol such as IPsec.

Specifically, embodiments of the invention provide a method and system to partition and virtualize packet security and steering using multiple levels of classifications, multiple security association database (SADB) partitions corresponding to at least one cryptographic offload engine, and multiple security policy database (SPD) partitions corresponding to at least one policy engine. In one embodiment of the invention, the classifiers, the cryptographic offload engine and the policy engine may be located in a network interface card (NIC) attached to a host. Further, in one embodiment of the invention, each SADB partition may also be associated with an internet key exchange (IKE) daemon, where the IKE daemons reside on the host, which generated SAs stored in the SADB partition. In addition, each SPD partition may be associated with a destination policy database located on the host.

In one embodiment of the invention, an application or container associated with a SADB partition and/or a SPD partition may only be allowed to access the SAs in the SADB partition and/or the security policies in the SPD partition. In one embodiment of the invention, such a configuration enables multiple security policies to be implemented independently on a single computer.

In one or more embodiments of the invention, multiple levels of classification may be implemented using two sets of classifiers and receive/transmit rings. One set may correspond to incoming packets received by the NIC, which may be decrypted by the cryptographic offload engine. The second set may process packets in clear text after decryption by the cryptographic offload engine and admittance by the policy engine.

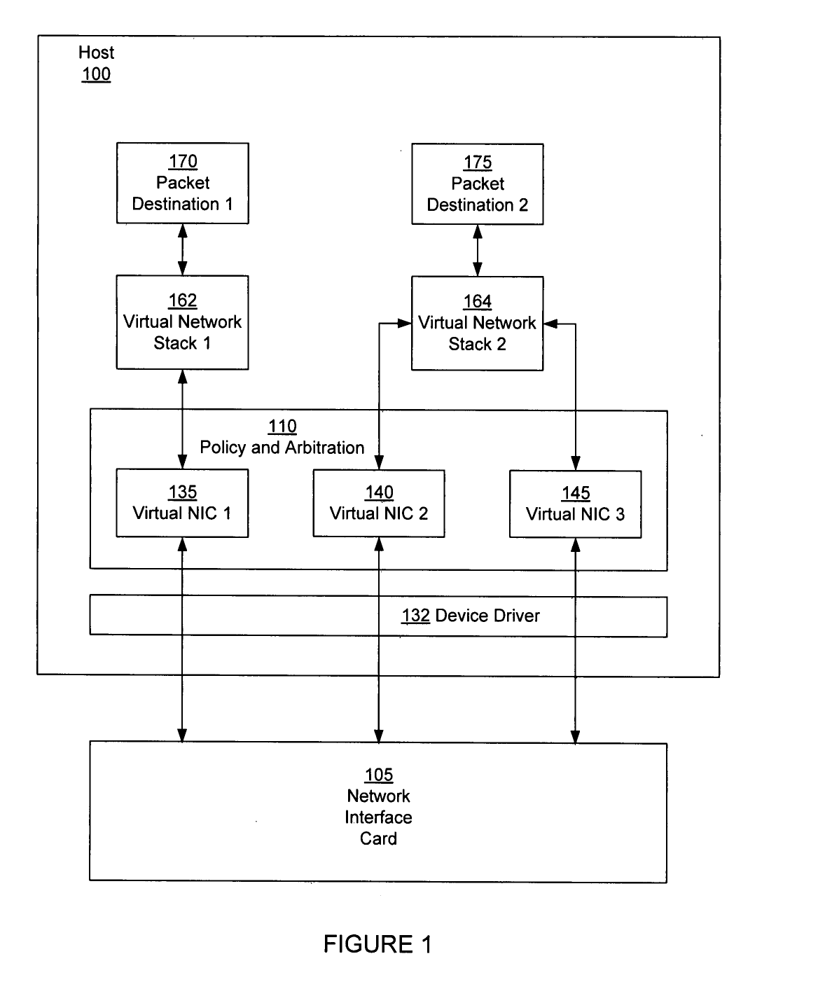

FIG. 1 shows a schematic diagram of a system in accordance with one or more embodiments of the invention. As shown in FIG. 1, the system includes a host (100), a network interface card (NIC) (105), multiple virtual network stacks (e.g., virtual network stack 1 (162), virtual network stack 2 (164)), multiple virtual NICs (e.g., virtual NIC 1 (135), virtual NIC 2 (140), virtual NIC 3 (145)), and multiple packet destinations (e.g., packet destination 1 (170), packet destination 2 (175). Each of these components is described below.

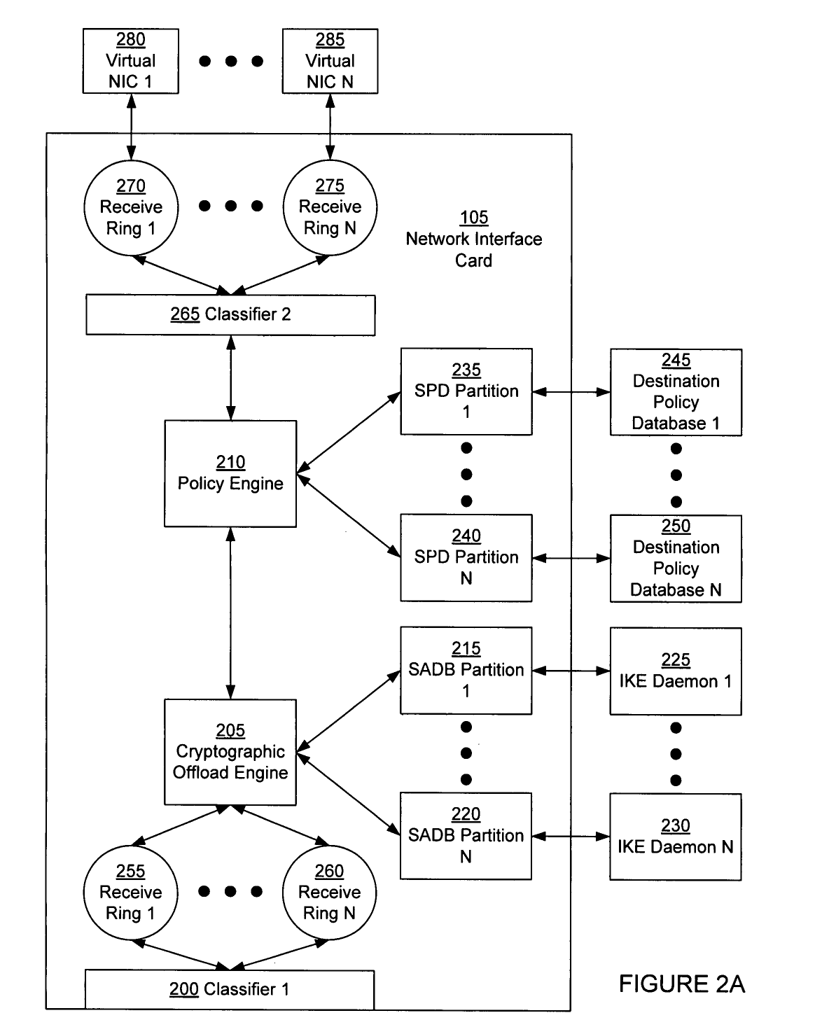

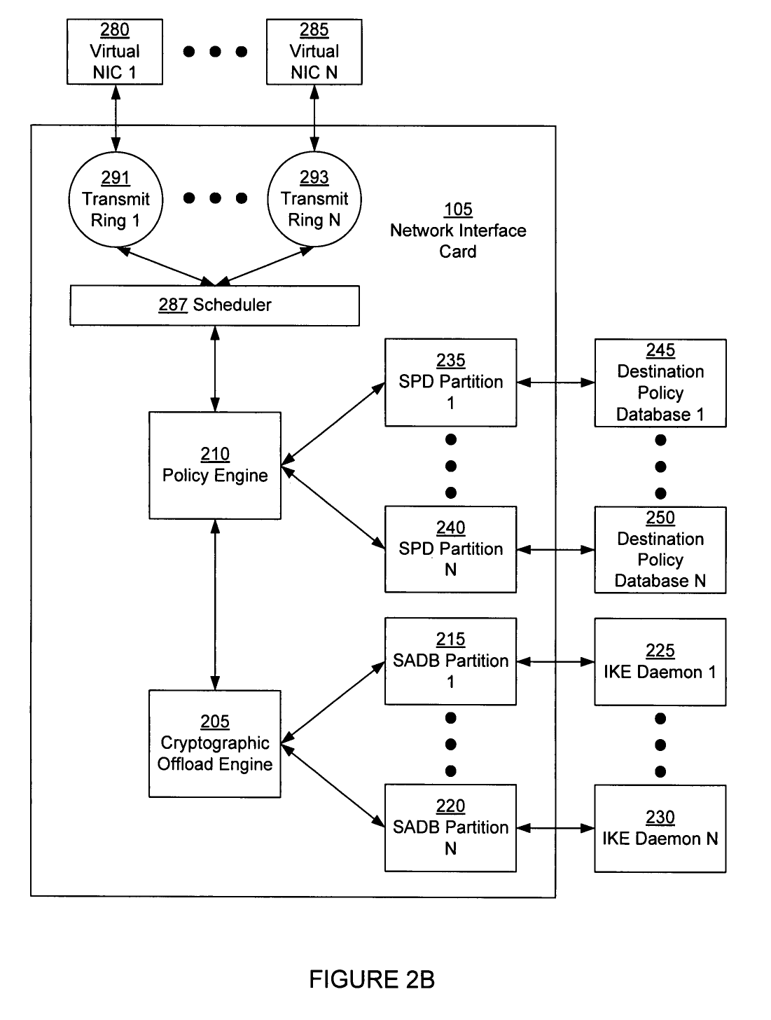

In one embodiment of the invention, the NIC (105) provides an interface between the host (100) and a network (not shown) (e.g., a local area network, a wide area network, a wireless network, etc.). More specifically, the NIC (105) includes a network interface (NI) (i.e., the hardware on the NIC used to interface with the network) configured to receive packets from the network and send packets to the network. For example, the NI may correspond to an RJ-45 connector, a wireless antenna, etc. The packets received by the NI are forwarded to other components on the NIC (105) for processing. In one embodiment of the invention, the NIC (105) includes one or more receive rings (not shown). In one embodiment of the invention, the receive rings correspond to portions of memory within the NIC (105) used to temporarily store packets received from the network. The NIC (105) is explained in further detail with respect to FIGS. 2A and 2B below.

In one or more embodiments of the invention, the host (100) may include a device driver (132) and one or more virtual NICs (e.g., virtual NIC 1 (135), virtual NIC 2 (140), virtual NIC 3 (145)). In one embodiment of the invention, the device driver (132) provides an interface between the NIC (105) and the host (100). More specifically, the device driver (132) exposes the NIC (105) to the host (100). In one embodiment of the invention, each of the virtual NICs (e.g., virtual NIC 1 (135), virtual NIC 2 (140), virtual NIC 3 (145)) is associated with one or more receive rings on the NIC (105). In other words, a virtual NIC (e.g., virtual NIC 1 (135), virtual NIC 2 (140), virtual NIC 3 (145)) receives incoming packets from a corresponding receive ring(s) on the NIC (105). Similarly, in one or more embodiments of the invention, outgoing packets are forwarded from a virtual NIC (e.g., virtual NIC 1 (135), virtual NIC 2 (140), virtual NIC 3 (145)) to a corresponding transmit ring (not shown), which temporarily stores the packet before transmitting the packet over the network.

In one or more embodiments of the invention, the virtual NICs (e.g., virtual NIC 1 (135), virtual NIC 2 (140), virtual NIC 3 (145)) are operatively connected to packet destinations (e.g., packet destination 1 (170), packet destination 2 (175)), which include containers and/or applications, via virtual network stacks (e.g., virtual network stack (162), virtual network stack 2 (164)). The virtual NICs (e.g., virtual NIC 1 (135), virtual NIC 2 (140), virtual NIC 3 (145)) provide an abstraction layer between the NIC (105) and the packet destinations (e.g., packet destination 1 (170), packet destination 2 (175)) on the host (100). More specifically, each virtual NIC (e.g., virtual NIC 1 (135), virtual NIC 2 (140), virtual NIC 3 (145)) operates like a NIC (105). For example, in one embodiment of the invention, each virtual NIC (e.g., virtual NIC 1 (135), virtual NIC 2 (140), virtual NIC 3 (145)) is associated with one or more Internet Protocol (IP) addresses, associated with one or more MAC addresses, optionally associated with one or more ports, optionally associated with one or more virtual Local Area Network (VLAN) tags, and optionally configured to handle one or more protocol types. Thus, while the host (100) may be operatively connected to a single NIC (105), packet destinations (e.g., packet destination 1 (170), packet destination 2 (175)), such as containers or applications, executing on the host (100) operate as if the host (100) is bound to multiple NICs.

In one embodiment of the invention, each virtual network stack (e.g., virtual network stack (162), virtual network stack 2 (164)) includes functionality to process packets in accordance with various protocols used to send and receive packets (e.g., Transmission Communication Protocol (TCP), Internet Protocol (IP), User Datagram Protocol (UDP), etc.). Further, each virtual network stack may also include functionality, as needed, to perform additional processing on the incoming and outgoing packets. This additional processing may include, but is not limited to, cryptographic processing, firewall routing, etc.

In one or more embodiments of the invention, the virtual network stacks (e.g., virtual network stack (162), virtual network stack 2 (164)) correspond to network stacks with network layer and transport layer functionality. In one embodiment of the invention, network layer functionality corresponds to functionality to manage packet addressing and delivery on a network (e.g., functionality to support IP, Address Resolution Protocol (ARP), Internet Control Message Protocol, etc.). In one embodiment of the invention, transport layer functionality corresponds to functionality to manage the transfer of packets on the network (e.g., functionality to support TCP, UDP, Stream Control Transmission Protocol (SCTP), etc.). In one or more embodiments of the invention, the virtual network stacks (e.g., virtual network stack (162), virtual network stack 2 (164)) implement an IP layer (not shown) and a TCP layer (not shown).

FIG. 2A shows a schematic diagram of a system for processing incoming packets in accordance with one or more embodiments of the invention. In one or more embodiments of the invention, the system of FIG. 2A is used to implement virtualization and partitioning of packet security and steering. In addition, the security protocol virtualization and partitioning may be applied to the system of FIG. 1, as explained below. The system of FIG. 2A includes a NIC (105) (corresponding to NIC (105) in FIG. 1) and a network (200). The NIC (105) further includes a cryptographic offload engine (205), a policy engine (210), multiple security association database (SADB) partitions (e.g., SADB partition 1 (215), SADB partition n (220)), and multiple security policy database (SPD) partitions (e.g., SPD partition 1 (235), SPD partition n (240)). Additionally, the NIC (105) may be operatively connected to a host, such as the host of FIG. 1. Each of these components is described in further detail below.

As mentioned previously, the NIC (105) is responsible for sending and receiving packets to and from other network devices on a network (200). To secure the transmission of packets over the network (200), packets in the NIC (105) may be encrypted before being transmitted over the network (200) or decrypted after receipt from another host (or other device operatively connected to the network) on the network (200). In one or more embodiments of the invention, a security protocol is implemented to encrypt, decrypt, and/or authenticate packets sent and received by the NIC (105) over the network (200). In one or more embodiments of the invention, the security protocol used to encrypt, decrypt, and/or authenticate packets sent and received by the NIC (105) over the network (200) is Internet Protocol Security (IPsec). The IPsec security model is described in Request for Comments (RFC) 4301-4309, all of which are incorporated by reference. Those skilled in the art will appreciate that other security protocols, such as Secure Sockets Layer (SSL) and Transport Layer Security (TLS), may also be partitioned and virtualized using one or more embodiments of the invention.

In one embodiment of the invention, analyzing individual packets includes determining to which of the receive rings (e.g., receive ring 1 (115), receive ring 2 (120), receive ring 3 (125)) each packet is forwarded. In one embodiment of the invention, analyzing the packets by the classifier (110) includes analyzing one or more fields in each of the packets to determine to which of the receive rings (e.g., receive ring 1 (115), receive ring 2 (120), receive ring 3 (125)) the packets are forwarded. As an alternative, the classifier (110) may use the contents of one or more fields in each packet as an index into a data structure that includes information necessary to determine to which receive ring (e.g., receive ring 1 (115), receive ring 2 (120), receive ring 3 (125)) that packet is forwarded. The classifier (110) may also use other data found in the packet, such as the destination Media Access Control (MAC) address, to classify the packet. The classifier (110) may be implemented by a separate microprocessor (not shown) embedded on the NIC (105). Alternatively, the classifier (110) may be implemented in software stored in memory (e.g., firmware, etc.) on the NIC (105) and executed by a microprocessor (not shown) on the NIC (105). In one or more embodiments of the invention, receive rings (e.g., virtual NIC 1 (135), virtual NIC 2 (140), virtual NIC 3 (145)) and transmit rings (not shown) are implemented as ring buffers in the NIC (105).

In one or more embodiments of the invention, encryption and decryption of packets, as well as implementation of security policies, may be executed using a central processing unit (CPU) on a host associated with the NIC (105). For example, IPsec Authenticating Header (AH), Encapsulating Security Payload (ESP), and packet encryption and decryption may be carried out using a CPU on the host of FIG. 1. Alternatively, IPsec AH, ESP, encryption and decryption may be partially or wholly implemented using a cryptographic offload engine (205) and/or a policy engine (210) located on the NIC (105). In one or more embodiments of the invention, a processor (not shown) and memory (not shown) on the NIC (105) are used to implement the cryptographic offload engine (205), policy engine (210), SADB partitions (e.g., SADB partition 1 (215), SADB partition n (220)), and SPD partitions (e.g., SPD partition 1 (235), SPD partition n (240)).

As shown in FIG. 2A, the cryptographic offload engine (205) is associated with multiple SADB partitions (e.g., SADB partition 1 (215), SADB partition n (220)). Similarly, the policy engine (210) is associated with multiple SPD partitions (e.g., SPD partition 1 (235), SPD partition n (240)). The SADB partitions (e.g., SADB partition 1 (215), SADB partition n (220)) and/or SPD partitions (e.g., SPD partition 1 (235), SPD partition n (240)) may be located on shared memory on the NIC (105). Further, the SADB partitions (e.g., SADB partition 1 (215), SADB partition n (220)) and/or SPD partitions (e.g., SPD partition 1 (235), SPD partition n (240)) may refer to database partitions within a single database and/or disk partitions within the memory on the NIC (105). Those skilled in the art will appreciate that the SADB partitions (e.g., SADB partition 1 (215), SADB partition n (220)) and/or SPD partitions (e.g., SPD partition 1 (235), SPD partition n (240)) may be distributed across multiple storage devices. For example, the SADB partitions (e.g., SADB partition 1 (215), SADB partition n (220)) and/or SPD partitions (e.g., SPD partition 1 (235), SPD partition n (240)) may be located in multiple memory devices on the NIC (105), multiple disk drives on the host, or a combination of storage devices on the NIC (105) and host.

In one or more embodiments of the invention, each SADB partition (e.g., SADB partition 1 (215), SADB partition n (220)) and SPD partition (e.g., SPD partition 1 (235), SPD partition n (240)) is associated with an identifier, a capacity, and an address. The identifier may correspond to a unique name for the SADB partition (e.g., SADB partition 1 (215), SADB partition n (220)) or SPD partition (e.g., SPD partition 1 (235), SPD partition n (240)). The capacity may refer to the partition's storage capacity. The address may refer to the memory address of the partition. In one or more embodiments of the invention, the identifier, capacity, and address are stored on the host and managed by a processor executing on the host. Further, the aforementioned process executing on the host may also include functionality to create, allocate, and destroy SADB partitions (e.g., SADB partition 1 (215), SADB partition n (220)) and SPD partitions (e.g., SPD partition 1 (235), SPD partition n (240)) on the NIC (105).

In one or more embodiments of the invention, the SADB partitions (e.g., SADB partition 1 (215), SADB partition n (220)) store security associations (SAs) used to secure network traffic between the NIC (105) and other network devices over the network (200). In one or more embodiments of the invention, an SA corresponds to a logical connection that allows security information to be shared between two network entities to support secure communication. For example, an SA may be used to secure a network connection between the NIC (105) and another NIC on the network (200) using packet encryption and/or authentication. In addition, the SA may include one or more cryptographic keys, initialization vectors, encodings of cryptographic algorithms used for authentication and/or encryption, and/or digital certificates. In other words, an SA corresponds to a group of security parameters for sharing information with another entity on the network (200). In one or more embodiments of the invention, the cryptographic offload engine (205) exchanges SAs in the SADB partitions (e.g., SADB partition 1 (215), SADB partition n (220)) with other hosts on the network (200). In addition, the cryptographic offload engine (205) may authenticate, encrypt, and/or decrypt incoming and outgoing packets using SAs in the SADB partitions (e.g., SADB partition 1 (215), SADB partition n (220)). In one or more embodiments of the invention, SAs in the SADB partitions (e.g., SADB partition 1 (215), SADB partition n (220)) correspond to IPsec SAs.

In one or more embodiments of the invention, the SPD partitions (e.g., SPD partition 1 (235), SPD partition n (240)) store security policies (SPs), which dictate access to packet destinations on a host operatively connected to the NIC (105), such as the host of FIG. 1. In one or more embodiments of the invention, an SP corresponds to a rule or set of rules that determine how packets in the NIC (105) are processed. For example, an SP may determine whether outgoing packets are to be authenticated or encrypted using the security protocol. In addition, an SP may determine whether incoming packets are allowed or denied access past the policy engine (210). An SP may further specify how packets which are denied access are processed. For example, the SP may dictate that packets denied access are dropped, or, alternatively, that the packets are stored for future reference. In one or more embodiments of the invention, the policy engine (210) is responsible for implementing the SPs stored in the SPD partitions (e.g., SPD partition 1 (235), SPD partition n (240)). In one or more embodiments of the invention, SPs in the SPD partitions (e.g., SPD partition 1 (235), SPD partition n (240)) correspond to IPsec SPs.

In one or more embodiments of the invention, each packet destination in the host is associated with an SADB partition (e.g., SADB partition 1 (215), SADB partition n (220)) and an SPD partition (e.g., SPD partition 1 (235), SPD partition n (240)) on the NIC (105). In other words, security rules regarding connections to a packet destination are specified in the SP(s) of the corresponding SPD partition (e.g., SPD partition 1 (235), SPD partition n (240)). Similarly, cryptographic keys, initialization vectors, digital certificates, etc. for authenticating, encrypting, and/or decrypting packets associated with the packet destination are stored in the SA(s) of the corresponding SADB partition (e.g., SADB partition 1 (215), SADB partition n (220)). Further, utilities associated with the packet destination, such as internet key exchange (IKE) daemons (e.g., IKE daemon 1 (225), IKE daemon n (230)) and destination policy databases (e.g., destination policy database 1 (245), destination policy database n (250)) are only allowed access to the partitions assigned to the packet destination, thus preventing unauthorized access to other partitions by the packet destination and associated utilities.

In one or more embodiments of the invention, each SADB partition (e.g., SADB partition 1 (215), SADB partition n (220)) is associated with an IKE daemon (e.g., IKE daemon 1 (225), IKE daemon n (230)) on the host. In one or more embodiments of the invention, SAs in an SADB partition (e.g., SADB partition 1 (215), SADB partition n (220)) are created and maintained by the corresponding IKE daemon (e.g., IKE daemon 1 (225), IKE daemon n (230)) in accordance with RFC 4301-4309, all of which are incorporated by reference.

In one or more embodiments of the invention, each SPD partition (e.g., SPD partition 1 (235), SPD partition n (240)) is associated with a destination policy database (e.g., destination policy database 1 (245), destination policy database n (250)) on the host. In one or more embodiments of the invention, SPs for a packet destination on the host are created and stored in the destination policy database (e.g., destination policy database 1 (245), destination policy database n (250)) corresponding to the packet destination. The SPs in the destination policy database (e.g., destination policy database 1 (245), destination policy database n (250)) may be transferred to the SPD partition (e.g., SPD partition 1 (235), SPD partition n (240)) associated with the packet destination to allow the policy engine (210) to access the SPs.

The NIC (105) of FIG. 2A may also implement steering of incoming packets using two sets of classifiers (e.g., classifier 1 (200), classifier 2 (265)) and two sets of receive rings (e.g., receive ring 1 (255), receive ring n (260), receive ring 1 (270), receive ring n (275)). In one embodiment of the invention, the classifiers (e.g., classifier 1 (200), classifier 2 (265)) are responsible for analyzing individual packets to determine to which of the receive rings (e.g., receive ring 1 (255), receive ring n (260), receive ring 1 (270), receive ring n (275)) each packet is forwarded. In one embodiment of the invention, analyzing the packets by the classifiers (e.g., classifier 1 (200), classifier 2 (265)) includes analyzing one or more fields in each of the packets to determine to which of the receive rings (e.g., receive ring 1 (255), receive ring n (260), receive ring 1 (270), receive ring n (275)) the packets are forwarded.

As an alternative, the classifiers (e.g., classifier 1 (200), classifier 2 (265)) may use the contents of one or more fields in each packet as an index into a data structure that includes information necessary to determine to which receive ring (e.g., receive ring 1 (255), receive ring n (260), receive ring 1 (270), receive ring n (275)) that packet is forwarded. The classifiers (e.g., classifier 1 (200), classifier 2 (265)) may also use other data found in the packet, such as the destination Media Access Control (MAC) address, to classify the packet. The classifiers (e.g., classifier 1 (200), classifier 2 (265)) may be implemented by separate microprocessors (not shown) embedded on the NIC (105). Alternatively, the classifiers (e.g., classifier 1 (200), classifier 2 (265)) may be implemented in software stored in memory (e.g., firmware, etc.) on the NIC (105) and executed by a microprocessor (not shown) on the NIC (105).

In one embodiment of the invention, the receive rings (e.g., receive ring 1 (255), receive ring n (260), receive ring 1 (270), receive ring n (275)) correspond to portions of memory within the NIC (105) used to temporarily store packets received from the network. In addition, the second set of receive rings (e.g., receive ring 1 (270, receive ring n (275)) may be used to implement bandwidth control for packets destined for the host. In one or more embodiments of the invention, the receive rings (e.g., receive ring 1 (255), receive ring n (260), receive ring 1 (270), receive ring n (275)) are implemented as ring buffers in the NIC (105).

In one or more embodiments of the invention, resources on the NIC (105) are managed by a policy and arbitration module on the host, such as the policy and arbitration module (110) of FIG. 1. For example, the policy and arbitration module may be responsible for assigning SADB partitions and SPD partitions to receive rings. Further, the policy and arbitration module (110) may be responsible for allocating SADB and SPD partition capacities, allocating receive ring sizes, allocating bandwidth to receive rings, virtualizing receive rings, etc. In other words, the policy and arbitration module (110) allocates resources on the NIC (105) to components (e.g., virtual NICs, packet destinations, etc.) on the host.

In one or more embodiments of the invention, encrypted packets from a network (not shown) are received by classifier 1 (200) and placed in a first receive ring (e.g., receive ring 1 (255), receive ring n (260)) by the classifier. In one or more embodiments of the invention, classifier 1 (200) uses a visible part of the packet header, such as a MAC and/or IP address, to classify the packets. The packets are placed into a receive ring in one of the first set of receive rings (e.g., receive ring 1 (255), receive ring n (260)) based on the classification. The packets are then sent to the cryptographic offload engine (205) for decryption.

In one or more embodiments of the invention, each of the first set of receive rings (e.g., receive ring 1 (255), receive ring n (260)) is associated with one of the SADB partitions (e.g., SADB partition 1 (215), SADB partition n (220)). As a result, encrypted packets in each receive ring (e.g., receive ring 1 (255), receive ring n (260)) may be decrypted using an SA from the corresponding SADB partition (e.g., SADB partition 1 (215), SADB partition n (220)). Once the packets are decrypted, the packets are sent to the policy engine (210), where one or more SPs associated with the packets may be retrieved. Based on the SP(s), the packets may be admitted or denied access to the host connected to the NIC (105). For example, the SP(s) may block all packets that are not from a local area network (LAN) associated with the NIC (105). Blocked packets may then be handled according to the SP(s). For example, the blocked packets may be dropped, or the blocked packets may be stored for future reference and/or analysis.

If the packets are admitted into the system, the packets are placed into classifier 2 (265), which classifies the packets and places the packets into corresponding receive rings (e.g., receive ring 1 (270), receive ring n (275)). In one or more embodiments of the invention, classifier 2 (265) uses packet payloads, HyperText Transfer Protocol (HTTP) Universal Resource Locators (URLs), and/or Extensible Markup Language (XML) content in the packets to classify the packets and place the packets into the appropriate receive rings (e.g., receive ring 1 (270), receive ring n (275)). Those skilled in the art will appreciate that other information in the packets may be used by classifier 2 (265) to classify the packets. The packets may then be sent to virtual NICs (e.g., virtual NIC 1 (280), virtual NIC n (285)) corresponding to the receive rings (e.g., receive ring 1 (270), receive ring n (275)). The rate at which the packets are transferred from the NIC (104) to the host is based on bandwidth control parameters associated with the receive rings. In other words, the packets may be stored in the receive rings (e.g., receive ring 1 (270), receive ring n (275)) and transmitted to the virtual NICs (e.g., virtual NIC 1 (280), virtual NIC n (285)) at a specified bandwidth.

FIG. 2B shows a schematic diagram of a system for processing outgoing packets in accordance with one or more embodiments of the invention. In one or more embodiments of the invention, the system of FIG. 2B is used to implement virtualization and partitioning of packet security and steering. In addition, the virtualization and partitioning may be applied to the system of FIG. 1, as explained below. The system of FIG. 2B includes a NIC (105) (corresponding to NIC (105) in FIG. 1 and FIG. 2A). The NIC (105) further includes a cryptographic offload engine (205), a policy engine (210), multiple security association database (SADB) partitions (e.g., SADB partition 1 (215), SADB partition n (220)), and multiple security policy database (SPD) partitions (e.g., SPD partition 1 (235), SPD partition n (240)), as in FIG. 2A. In one or more embodiments of the invention, the above components of the NIC (105) correspond to the same components in FIG. 2A. However, instead of receive rings, the NIC (105) of FIG. 2B includes one set of transmit rings (e.g., transmit ring 1 (291), transmit ring n (293)). In addition, the NIC of FIG. 2B also includes a scheduler (287) instead of two classifiers.

In one or more embodiments of the invention, the transmit rings (e.g., transmit ring 1 (291), transmit ring n (293)) are used to store packets temporarily before the packets are transmitted over a network (not shown). In other words, the transmit rings (e.g., transmit ring 1 (291), transmit ring n (293)) are used to store outgoing packets from the host (e.g., host (100) in FIG. 1) prior to transmission over the network. In addition, bandwidth control may be implemented by the scheduler (287). In other words, the packets may be stored in the transmit rings (e.g., transmit ring 1 (291), transmit ring n (293)) and processed at a specified bandwidth based on bandwidth control parameters associated with the transmit rings. In one or more embodiments of the invention, the scheduler (287) regulates bandwidth by controlling the flow of outbound packets from the transmit rings (e.g., transmit ring 1 (291), transmit ring n (293)) to the policy engine (210)

In one or more embodiments of the invention, packets from the host are sent from virtual NICs (e.g., virtual NIC 1 (280), virtual NIC n (285)) in the host to corresponding transmit rings (e.g., transmit ring 1 (291), transmit ring n (293)). The packets may then pass through the scheduler (287) to the policy engine (210) according to one or more bandwidth control parameters carried out by the scheduler (287). At the policy engine (210), one or more SPs may be applied to the packets. As with the receive rings, each of the transmit rings (e.g., transmit ring 1 (291), transmit ring n (293)) may correspond to an SPD partition (e.g., SPD partition 1 (235), SPD partition n (240)). As a result, SPs from an SPD partition (e.g., SPD partition 1 (235), SPD partition n (240)) may be applied to packets from the transmit ring (e.g., transmit ring 1 (291), transmit ring n (293)) corresponding to the SPD partition.

In one or more embodiments of the invention, the SPs may dictate whether the packets need to be encrypted or authenticated before being transmitted over the network. The SPs may also dictate whether the packets are permitted to be transmitted over the network. For example, a packet may be blocked from transmission if the packet is addressed to a host that resides outside a LAN associated with the NIC (105).

Based on the SPs associated with the packets, the packets may be sent to the cryptographic offload engine (205) for authentication or encryption before transmission over the network. To authenticate or encrypt the packets, the cryptographic offload engine (205) may retrieve one or more SAs from the SADB partition (e.g., SADB partition 1 (215), SADB partition n (220)) corresponding to the transmit ring (e.g., transmit ring 1 (291), transmit ring n (293)) from which the packets were received. The packets may then be authenticated or encrypted using the SA(s) and sent over the network. Alternatively, if the packets do not require authentication or encryption, the packets may pass through the cryptographic offload engine (205) without applying any SAs to the packets. As another option, the packets may bypass the cryptographic offload engine (205) completely.

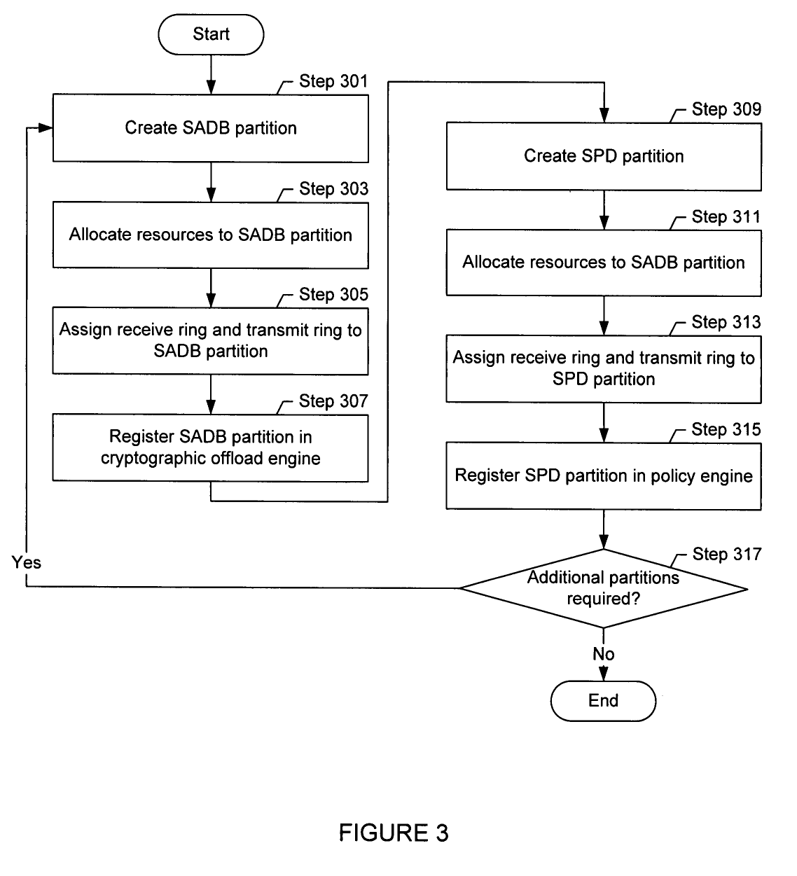

FIG. 3 shows a flow diagram of partition creation in accordance with one or more embodiments of the invention. In one or more embodiments of the invention, one or more of the steps described below may be omitted, repeated, and/or performed in a different order. Accordingly, the specific arrangement of steps shown in FIG. 3 should not be construed as limiting the scope of the invention.

Initially, an SADB partition is created (Step 301). As mentioned above, the SADB partition may be associated with a packet destination on a host. The SADB partition may store SAs for connections with the packet destination. In addition, the SADB partition may include a reference to a database partition and/or a disk partition. The SAs may also be accessible by a cryptographic offload engine located on a NIC attached to the host. SADB partition creation is described in further detail with respect to U.S. patent application Ser. No. 11/731,601 (Attorney Docket No. 03227/015001) entitled “Method and System for Security Protocol Partitioning and Virtualization” assigned to the same entity, filed on Mar. 30, 2007 and incorporated herein by reference.

Resources are also allocated to the SADB partition (Step 303). As mentioned above, resources on the NIC may be allocated using a policy and arbitration module (110) on the host. With respect to the SADB partition, resources allocated may include memory, processor usage, etc. Resources allocated to the SADB partition may also include one or more receive rings and one or more transmit rings (Step 305). In one or more embodiments of the invention, one of a first set of receive rings and one of a second set of receive rings may be assigned to the SADB partition, as explained above with respect to FIG. 2A. In addition, one of a first set of transmit rings and one of a second set of transmit rings may also be assigned to the SADB partition, as explained above with respect to FIG. 2B. Those skilled in the art will appreciate that one or more receive rings and/or transmit rings may be assigned to the same SADB partition. Similarly, those skilled in the art will appreciate that one or more SADB partitions may be associated with the same receive ring(s) and/or transmit ring(s).

Once the aforementioned information is obtained, the SADB partition is registered in a cryptographic offload engine (Step 307), which may be located on a NIC operatively connected to the host. The SADB partition may be registered using a process executing on the host. Further, the SADB partition may be associated with an IKE daemon on the host, which may begin populating the SADB partition with SAs for the packet destination.

An SPD partition is also created (Step 309). In one or more embodiments of the invention, the SPD partition is also associated with the packet destination on the host. In one or more embodiments of the invention, the SPD partition stores SPs associated with the packet destination. As with the SADB partition, resources on the NIC are allocated to the SPD partition (Step 311) using a policy and arbitration module (110) on the host, and a receive ring and/or transmit ring is assigned to the SPD partition (Step 313). The SPD partition is then registered in a policy engine (Step 315), which may also be located on the NIC. In one embodiment of the invention, the SPD partition may also be registered using a process executing on the host. In addition, the SPD partition may be associated with a destination policy database on the host, which may begin transferring SPs to the SPD partition from the host. SPD partition creation is described in further detail with respect to U.S. patent application Ser. No. 11/731,601 (Attorney Docket No. 03227/015001) entitled “Method and System for Security Protocol Partitioning and Virtualization” assigned to the same entity, filed on Mar. 30, 2007, and incorporated herein by reference.

A determination is made regarding whether additional partitions are required (Step 317). For example, additional SADB and SPD partitions may be added for other packet destinations on the host. Additional SADB and SPD partitions may also be added for the packet destination to further virtualized and partition security protocol implementations for the packet destination. If additional partitions are to be added, additional SADB partitions and SPD partitions are created and registered in accordance with Steps 301-315 described above.

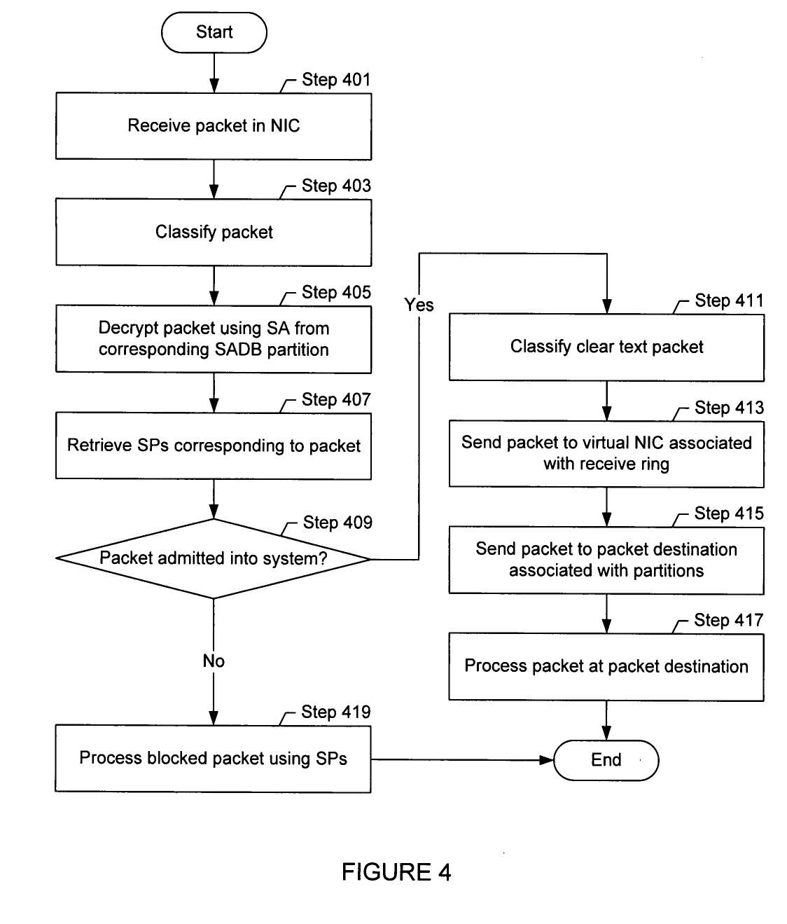

FIG. 4 shows a flow diagram of incoming packet processing in accordance with one or more embodiments of the invention. In one or more embodiments of the invention, one or more of the steps described below may be omitted, repeated, and/or performed in a different order. Accordingly, the specific arrangement of steps shown in FIG. 4 should not be construed as limiting the scope of the invention.

Initially, an incoming packet is received in a NIC (Step 401). The packet may be an incoming packet from any host on the network. Once the packet is received, the packet is classified (Step 403). As mentioned above, the packet may be classified using a first classifier in the NIC. Further, the packet may be classified by the first classifier using fields in the packet header, such as source/destination IP address, source/destination MAC address, etc. Those skilled in the art will appreciate that because the packet may be encrypted, valid information for classifying the packet may be found only in the packet header. As described above, the packet may be placed into a receive ring on the NIC as part of the packet's classification.

The packet is decrypted using an SA from an SADB partition (Step 405). Alternatively, if the packet is authenticated but not encrypted, the packet's authentication is verified using the SA. However, if the packet is neither authenticated nor encrypted, the application of SAs from the SADB partition may be bypassed entirely. As described above, the SADB partition may correspond to the receive ring in which the packet is placed. Similarly, SPs corresponding to the packet may be retrieved (Step 407) from an SPD partition corresponding to the receive ring the packet in which the packet is placed.

As mentioned previously, the SPs determine how incoming and outgoing packets are processed. Specifically, the SPs may determine if an outgoing packet requires security protocol processing (e.g., encryption, authentication, etc.), if an outgoing packet may bypass security protocol processing, and/or if an incoming packet is allowed into the system (Step 409). For example, an SP may block a packet's entry into the system after the packet is decrypted, even if the packet includes a security parameter index (SPI) and destination address for a packet destination in the system.

If the packet is allowed into the system, the packet, which is now in clear text, is classified (Step 411). As described above, classification of the clear text packet may be accomplished using a second classifier and set of receive rings on the NIC. Further, classification of the packet may involve using information found in the packet payload, as well as HTTP URLs, XML content, etc. Based on the second classification, the packet may be placed into a corresponding receive ring. The receive ring may also be associated with a virtual NIC on a host that is operatively connected to the NIC.

The packet may then be sent to the virtual NIC associated with the receive ring (Step 413). As stated above, bandwidth control may be implemented using the second set of receive rings on the NIC. As a result, the packet may be stored temporarily in the receive ring according to bandwidth control parameters before being sent to the virtual NIC. From the virtual NIC, the packet is sent to the packet destination associated with the SADB and SPD partitions (Step 415), where the packet is processed (Step 417). If the packet is blocked from entering the system, the blocked packet is processed according to SPs in the SPD partition (Step 419). For example, the packet may be dropped, or the packet may be stored in part or in whole for further analysis and/or future reference.

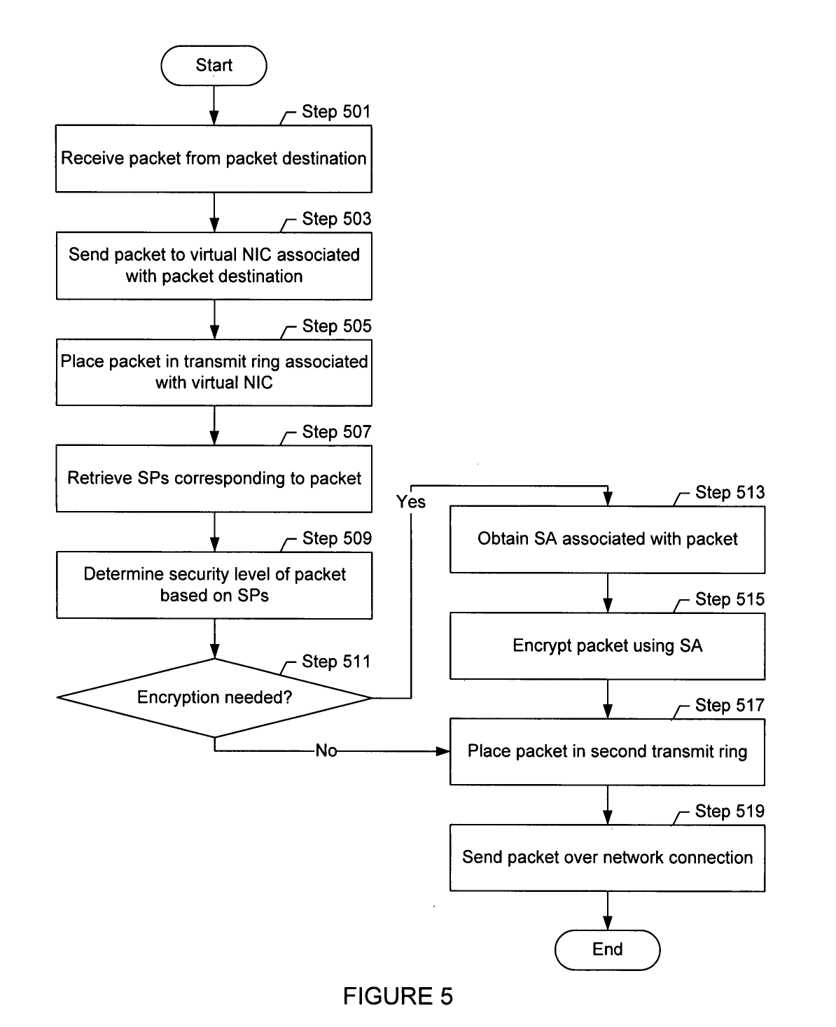

FIG. 5 shows a flow diagram of outgoing packet processing in accordance with one or more embodiments of the invention. In one or more embodiments of the invention, one or more of the steps described below may be omitted, repeated, and/or performed in a different order. Accordingly, the specific arrangement of steps shown in FIG. 5 should not be construed as limiting the scope of the invention.

Initially, the packet is received from a packet destination (Step 501). As mentioned previously, the packet destination may include an application, such as a web server or enterprise application. The packet destination may also include a container, or an isolated execution environment within the host. The packet is sent to a virtual NIC associated with the packet destination (Step 503). In addition, the packet may be processed by a virtual network stack (see FIG. 1) en route to the virtual NIC.

The packet is placed into a transmit ring associated with the virtual NIC (Step 505). As mentioned above, the transmit ring corresponds to a portion of memory within a NIC used to temporarily store the packet before transmitting the packet over a network. SPs corresponding to the packet are also retrieved (Step 507). The SPs may be found by accessing an SPD partition associated with the transmit ring. The SPs may also determine the security level of the packet (Step 509). For example, the SPs may dictate whether the packet is to be authenticated, encrypted (Step 511), or otherwise processed before being sent over the network.

If the packet requires encryption, an SA associated with the packet is obtained (Step 513). Like the SPs, the SA may be found by accessing an SADB partition associated with the transmit ring the packet was placed in initially. The packet is encrypted using the SA (Step 515) and placed in a second transmit ring (Step 517). As with the first transmit ring, the second transmit ring may be associated with the SADB partition and SPD partitions. Alternatively, the second transmit ring may correspond to a separate mapping of the packet's encryption, contents, etc. For example, the second transmit ring may correspond to packet size, encryption, authentication, etc. Further, the second transmit ring may implement a bandwidth control mechanism for transmitting packets over the network. As a result, the packet may be stored temporarily in the second transmit ring before being sent over a network connection (Step 519). If the packet does not require encryption, the packet is placed directly into a second transmit ring (Step 517), where the packet is transmitted over the network (Step 519).

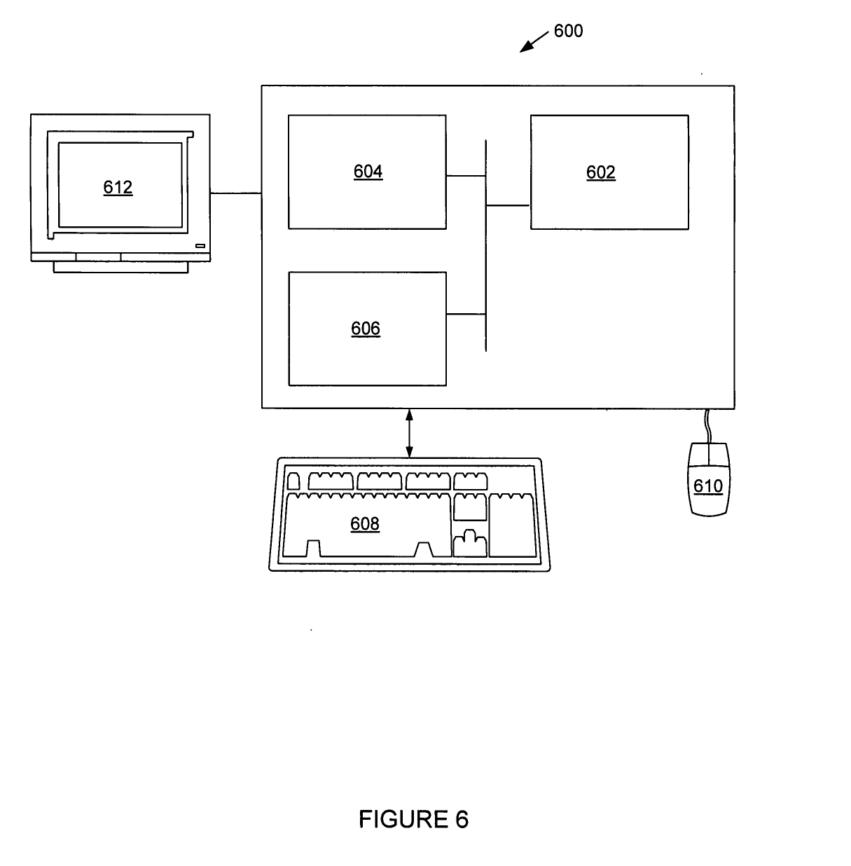

The invention may be implemented on virtually any type of computer regardless of the platform being used. For example, as shown in FIG. 6, a computer system (600) includes a processor (602), associated memory (604), a storage device (606), and numerous other elements and functionalities typical of today's computers (not shown). The computer (600) may also include input means, such as a keyboard (608) and a mouse (610), and output means, such as a monitor (612). The computer system (600) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (600) may be located at a remote location and connected to the other elements over a network. Further, the invention may be implemented on a distributed system having a plurality of nodes, where each portion of the invention (e.g., receive rings, transmit rings, cryptographic offload engine, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for processing a packet, comprising:
receiving the packet in a network interface card (NIC);
obtaining a first classification for the packet;
placing the packet in one of a first plurality of receive rings based on the first classification;
obtaining a security association (SA) from one of a plurality of security association database (SADB) partitions, wherein the one of the plurality of SADB partitions is associated with the one of the first plurality of receive rings;
decrypting the packet using the SA;
obtaining a security policy (SP) from one of a plurality of security policy database (SPD) partitions, wherein the one of the plurality of SPD partitions is associated with the one of the first plurality of receive rings;
determining an admittance of the packet based on the SP;
obtaining a second classification for the packet based on the admittance;
placing the packet in one of a second plurality of receive rings based on the second classification; and
sending the packet to a host operatively connected to the NIC, wherein the packet is further processed by the host.

2. The method of claim 1, further comprising:
sending the packet to a virtual NIC associated with the one of the second plurality of receive rings;
sending the packet to a packet destination associated with the virtual NIC; and
processing the packet at the packet destination.

3. The method of claim 2, wherein a bandwidth control associated with the packet destination is implemented using the second classification.

4. The method of claim 1, wherein each of the plurality of SADB partitions is associated with one of a plurality of internet key exchange (IKE) daemons.

5. The method of claim 1, wherein each of the plurality of SPD partitions is associated with one of a plurality of destination policy databases.

6. The method of claim 1, wherein each of the plurality of SADB partitions is associated with a cryptographic offload engine.

7. The method of claim 1, wherein each of the plurality of SPD partition is associated with a policy engine.

8. The method of claim 1, wherein the first plurality of receive rings and the second plurality of receive rings are managed by a policy and arbitration module located in the host.

9. The method of claim 1, wherein the first classification is based on a header of the packet.

10. The method of claim 1, wherein the second classification is based on an unencrypted portion of the packet.

11. A network interface card (NIC), comprising:
a first classifier configured to obtain a first classification for the packet;
a first plurality of receive rings, wherein the packet is placed in one of the first plurality of receive rings based on the first classification;
a plurality of security association database (SADB) partitions, wherein each of the plurality of SADB partitions is associated with one of the first plurality of receive rings;
a cryptographic offload engine configured to decrypt the packet using a security association (SA) from one of the plurality of SADB partitions;
a plurality of security policy database (SPD) partitions, wherein each of the plurality of SPD partitions is associated with one of the first plurality of receive rings;
a policy engine configured to determine an admittance of the packet using a security policy (SP) from one of the plurality of SPD partitions;
a second classifier configured to obtain a second classification for the packet; and
a second plurality of receive rings, wherein the packet is placed in one of the second plurality of receive rings based on the second classification.

12. The network interface card of claim 11, wherein each of the plurality of SADB partitions is associated with one of a plurality of internet key exchange (IKE) daemons on a host.

13. The network interface card of claim 11, wherein each of the plurality of SPD partitions is associated with one of a plurality of destination policy databases on a host.

14. The network interface card of claim 11, wherein the first plurality of receive rings and the second plurality of receive rings are managed by a policy and arbitration module on a host.

15. The network interface card of claim 11, wherein the first classifier uses an Internet Protocol (IP) address and a Media Access Control (MAC) address located in a header of the packet.

16. A method for processing a packet, comprising:
receiving the packet from a host, wherein the packet comprises a destination address;
placing the packet in one of a first plurality of transmit rings;
obtaining a security policy (SP) from one of a plurality of security policy database (SPD) partitions, wherein the one of the plurality of SPD partitions is associated with the one of the first plurality of transmit rings;
determining a security level of the packet based on the SP;
obtaining a security association (SA) from one of a plurality of security association database (SADB) partitions based on the security level, wherein the one of the plurality of SADB partitions is associated with the one of the first plurality of transmit rings;
encrypting the packet using the SA;
placing the packet in one of a second plurality of transmit rings; and
sending the packet over a network connection to the destination address.

17. The method of claim 16, wherein each of the plurality of SADB partitions is associated with one of a plurality of internet key exchange (IKE) daemons.

18. The method of claim 16, wherein each of the plurality of SPD partitions is associated with one of a plurality of destination policy databases.

19. The method of claim 16, wherein each of the plurality of SADB partitions is associated with a cryptographic offload engine and wherein the cryptographic offload engine is configured to encrypt the packet using the SA.

20. The method of claim 16, wherein each of the plurality of SPD partition is associated with a policy engine and wherein the policy engine is configured to determine the security level of the packet based on the SP.
